(19) United States
(12) Patent Application Publication
(10) Pub. No.: US 2020/0327122 A1
(43) Pub. Date: Oct. 15, 2020

(54) CONFLATION OF TOPIC SELECTORS

(71) Applicant: PUSH TECHNOLOGY LIMITED, Maidenhead (GB)

(72) Inventor: Philip Allan George Aston, Maidenhead (GB)

(21) Appl. No.: 16/087,984

(22) PCT Filed: Mar. 22, 2017
(86) PCT No.: PCT/IB2017/000375

§ 371 Date: Sep. 24, 2018

Related U.S. Application Data
(60) Provisional application No. 62/315,402, filed on Mar. 30, 2016.

(51) Int. Cl. G06F 16/2457; G06F 16/23

(52) U.S. Cl. CPC G06F 16/2457; G06F 16/2379

(57) ABSTRACT

A topic tree is comprised of a plurality of topics that clients can subscribe to and which are organized in a topic hierarchy. A topic selection list comprising a plurality of first topic selector expressions is stored. Each first topic selector expression is an expression that identifies a corresponding first subset of the topic tree which is being subscribed to or unsubscribed from. A second topic selector expression is then identified. The second topic selector expression is an expression that identifies a corresponding second subset of the topic tree which is being subscribed to or unsubscribed from. The plurality of first topic selector expressions are conflated with the second topic selector expression based on whether there is redundancy between the first topic selector expressions and the second topic selector expression.

### CROSS REFERENCE TO RELATED APPLICATIONS

This application claims the benefit of U.S. Provisional Patent Application No. 62/315,402 filed on Mar. 30, 2016, the contents of which are incorporated by reference in their entirety.

### FIELD OF ART

This disclosure generally relates to the field of data distribution, and more specifically, to managing topic selection information by a publishing system to decrease computational costs.

### BACKGROUND

The increased demand for data means that business systems and applications must exchange data efficiently and intelligently at scale with devices, browsers, and other applications over the Internet. To meet this increased demand for data, some data distribution platforms employ a publish-subscribe model in which senders of messages, called publishers, publish messages into classes (e.g., topics) without knowledge of subscribers who may receive the messages. Subscribers in a topic-based publish-subscribe system will receive all messages published to the topics to which they subscribe, and all subscribers to a topic will receive the same messages. Publishers establish a session with the server to create and maintain topics and clients establish a session with the server to consume data published by the publishers.

When a client subscribes to a topic, the publisher adds a new topic selector to the topic selections for that particular client session. When a new topic is added, the publisher evaluates the new topic's path against a very large number of unique topic selections for each client session. Thus, the cost of evaluating topic paths becomes computationally expensive due to the very large number of unique client sessions.

### SUMMARY

In one embodiment, a method of reducing computational costs for a system that includes a topic tree comprised of a plurality of topics that clients can subscribe to is disclosed. The topics in the topic tree are organized in a topic hierarchy. A topic selection list for a client is stored. The topic selection list comprises a plurality of first topic selector expressions, and each first topic selector expression is an expression that identifies a corresponding first subset of the topic tree which is being subscribed to or unsubscribed from. A second topic selector expression is identified. The second topic selector expression is an expression that identifies a corresponding second subset of the topic tree which is being subscribed to or unsubscribed from. The topic selection list is updated by conflating the plurality of first topic selector expressions with the second topic selector expression based on whether there is redundancy between the first topic selector expressions and the second topic selector expression.

In one embodiment, conflating the plurality of first topic selector expressions with the second topic selector expression comprises: determining, for a first topic selector expression of the first topic selector expressions, whether topic paths of the topic tree selected by the first topic selector expression are all selected by the second topic selector expression. The topic selection list is updated based on whether topic paths of the topic tree selected by the first topic selector expression are also all selected by the second topic selector expression.

In one embodiment, conflating the plurality of first topic selector expressions with the second topic selector expression comprises determining, for a first topic selector expression of the list of first topic selector expressions, whether topic paths of the topic tree selected by the second topic selector expression are also all selected by the first topic selector expression. The topic selection list is updated based on whether topic paths of the topic tree selected by the second topic selector expression are also all selected by the first topic selector expression. Conflating the plurality of first topic selector expressions with the second topic selector expression can comprise determining whether a subscription type associated with the first topic selector expression is same as a subscription type associated with the second topic selector expression. The topic selection list is updated further based on whether the subscription type associated with the first topic selector expression is same as the subscription type associated with the second topic selector expression.

In one embodiment, conflating the plurality of first topic selector expressions with the second topic selector expression comprises determining, for a first topic selector expression of the first topic selector expressions, whether topic paths of the topic tree selected by the first topic selector expression are independent of topic paths of the topic tree selected by the second topic selector expression. The topic selection list is updated based on whether topic paths of the topic tree selected by the first topic selector expression are independent of topic paths of the topic tree selected by the second topic selector expression. In one embodiment, the first topic selector expression includes a topic path and a wildcard associated with the topic path, wherein the wildcard is disregarded when determining whether topic paths of the topic tree selected by the first topic selector expression are independent of topic paths of the topic tree selected by the second topic selector expression.

In one embodiment, conflating the plurality of first topic selector expressions with the second topic selector expression comprises evaluating the first topic selector expressions of the list of first topic selections in reverse order.

In one embodiment, each first topic selector expression includes a corresponding path prefix that identifies a corresponding topic path corresponding to the subset of the topic tree.

In one embodiment, each first topic selector expression is associated with a value that indicates whether the topic selector expression is subscribing to or unsubscribing from the topic tree, and the conflating is further based on the value that indicates whether the topic selector expression is subscribing to or unsubscribing from the topic tree.

In one embodiment, the method further comprises evaluating the updated topic selections list against a topic path of a new topic added to the topic tree. One or more messages for the new topic are transmitting to the client responsive to the evaluation indicating that the topic paths subscribed to by the updated topic selections list match the new topic path.

In one embodiment, a non-transitory computer readable medium stores instructions for reducing computational costs. The instructions are executed by a processor and cause the processor to implement the method described herein.

### BRIEF DESCRIPTION OF THE DRAWINGS

FIG. 1 is a block diagram of a data distribution system, according to one embodiment.

FIG. 2 is a diagram illustrating a topic tree, and logical connections between a publisher and clients based on topics, according to one embodiment.

FIG. 3 is a flowchart illustrating a method of operating the data distribution system, according to one embodiment.

FIG. 4 is a flowchart illustrating additional details for the step of generating an updated list of topic selections by conflating a new topic selection with an existing list of topic selections from FIG. 3, according to one embodiment.

FIG. 5 is a schematic diagram of a computing device for implementing a server, according to one embodiment.

The figures depict embodiments for purposes of illustration only. One skilled in the art will readily recognize from the following description that alternative embodiments of the structures and methods illustrated herein may be employed without departing from the principles of the invention described herein.

### DETAILED DESCRIPTION

### Data Distribution System Architecture

In one embodiment, a method to reduce computational costs for a system that includes a topic tree is disclosed. The topic tree is comprised of a plurality of topics that clients can subscribe to and which are organized in a topic hierarchy. A topic selection list comprising a plurality of first topic selector expressions is stored. Each first topic selector expression is an expression that identifies a corresponding first subset of the topic tree which is being subscribed to or unsubscribed from. A second topic selector expression is then identified. The second topic selector expression is an expression that identifies a corresponding second subset of the topic tree which is being subscribed to or unsubscribed from. The plurality of first topic selector expressions are conflated with the second topic selector expression based on whether there is redundancy between the first topic selector expressions and the second topic selector expression.

This process of conflating topic selector expressions can reduce the number of topic selector expressions in a client's topic selection list, thereby allowing the topic selections to be evaluated against newly added topics in a more computationally efficient manner. Some embodiments of the conflation process can conflate topic selectors that cannot be precisely matched against each other. In addition, the conflation process can proceed in an ordered manner by evaluating one existing topic selector expression at a time in reverse order, starting at the end of the topic selection list with the most recently added topic selector expression, and iteratively working towards the beginning of the topic selection list.

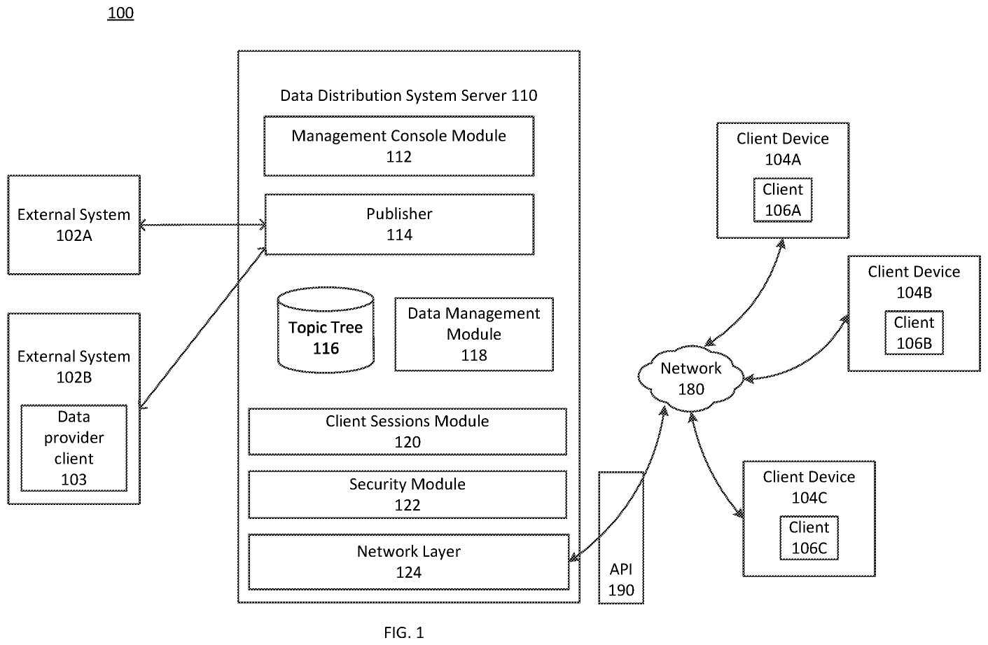

FIG. 1 is a block diagram of a data distribution system 100, according to one embodiment. The data distribution system 100 includes a data distribution system server 110, external systems 102, and client devices 104.

One or more external systems 102 interact with the data distribution system server 110 to distribute data to multiple client applications over a network. An external system may be a server associated with a data source for distribution via the data distribution system server 110. Example data sources include entities such as a stock exchange, an online game provider, a media outlet, or other source that distributes topical data to users over a network, such as the Internet.

The external system 102 communicates with the data distribution system server via a hosted application called a publisher 114, which enables the external system to create and maintain topics on the data distribution system server for distribution to multiple clients 106. Alternatively, publishers 114 may operate as a separate process external to the data distribution system server 110, in which case the publisher 114 is referred to as control clients. For example, the publisher 114 may be located within one of the external systems 102 instead of the data distribution server 110.

The client devices 104 communicate with the data distribution server 110 through a network 180. The client devices include clients 104. A client 106 can be an application that communicates with the data distribution system server 110 using one or more specified client protocols. Example client protocols include Web Socket (WS) and Hypertext Transfer Protocol (HTTP). Some clients connect to the data distribution system server to subscribe to topics and receive message data on those topics. Other clients 106, which have different permissions, perform control actions such as creating and updating topics or handling events. The category of client depends on the language of the application programming interface (API) and libraries used to implement it. Example APIs include JavaScript Unified API, Java Unified API, .NET Unified API, C Unified API, iOS Classic API, and Android Classic API. Example client libraries include Flex and JavaScript.

The clients 106 can include web clients 106a, mobile clients 106b, and enterprise clients 106c. Web clients include browser applications that use JavaScript, ActionScript, or Silverlight APIs. Enterprise clients may be any application connecting to the data distribution system server over a data distribution system server protocol for Transmission Control Protocol (TCP) over the Internet or an intranet/extranet using Java, .Net, or C APIs. Mobile clients may be mobile applications that interact with the data distribution system server using iOS or Android APIs.

Generally, clients 106 interact with the data distribution system server 110 using an API 190. The API 190 may include the libraries appropriate to the platform executing the client application. The category of client 106 depends on the language of the API and libraries used to implement it. Clients 106 may be implemented in one of a number of languages and use variety of protocols to communicate with the server 110. Clients may perform different types of actions depending on their permissions and the capabilities of the API they use.

Clients 106 used by data consumers typically subscribe to topics and receive from the data distribution system server 110 the updates that are published to these topics. Clients 103 used by data providers typically create, manage, and update topics. These clients 103 also take responsibility for control functions, for example authenticating and managing other client sessions.

The data distribution system server 110 hosts publisher applications 114 and a topic tree 116, manages connections and sessions from clients 106, and pushes data to the clients 106 through message queues. The data distribution system server 110 may be a standalone server or part of a cluster of servers to provide a scalable enterprise data distribution solution. The data distribution system server 110 pushes (streams) and receives data and events, in real-time, both to and from clients 106. The data distribution system server 110 includes a high performance network layer 124, security enforcement module 122, client session module 120, topic tree 116, data management module 118, publishers 114, and a management console 112.

The high performance network layer 124 handles a high number of concurrent connections without the need for separate threads. Connectors handle connections from many different types of clients 106 and for various protocols. Connectors may be configured to listen on different ports. Multiple clients 106 may connect to a single port.

The security enforcement module 122 authenticates all connections from clients 106 and manages authorization and setting permissions for actions that those clients 106 can take when they are connected to the data distribution system sever 110.

The client sessions module 120 manages the sessions for all of the clients 106 that connect to the data distribution system server 110. In one embodiment, as session is an interactive information interchange having a session state that can persist over multiple connections. The client sessions module 120 stores information about each client 106 and topic subscription information about the client's subscriptions to topics, such as by storing a list of topic selections. If a client 106 disconnects, it can reconnect to the same session within a specified time period using the information stored in the client session module 120.

The data management module 118 performs operations on the data to more efficiently deliver it to clients 106. Example operations include structural conflation, merging, and replacing data to ensure that the latest data is received by the client 106.

The management console module 112 may operate as an optional publisher that is deployed by default. The management console module 112 may be used to monitor the operations of the data distribution system server 110 through a web browser and to stop and start publishers 114 within the data distribution system server 110.

Publishers 114 can be components hosted within the data distribution system server 110 that manage the data for one or more topics and publish messages to any clients 106 that subscribe to the topics that the publisher 114 manages. In one example, publishers 114 are written using the Java API and extend the issued Publisher class and implement various methods to provide the publisher functionality. A publisher 114 maintains its own data model. The publisher initializes its data as it starts and updates it as a result of external events. When a client 106 first subscribes to a topic the publisher 114 provides the client 106 with a snapshot of the current state of the data relating to that topic. This is referred to as a “topic load.” A client can also request the current state of a topic, even if not subscribed to it, using the “fetch” command.

A publisher 114 maintains any changes to its topic data state and publishes those changes to the topic as delta messages. This results in the message being sent to every client 106 that is subscribed to the topic. Publishers 114 can send messages to individual clients 106 or to groups of clients 106 and can receive messages from clients 106. Under certain operating conditions, the publisher 114 does not need to know or keep track of the clients 106 subscribed to its topics. Publishers 114 own the topics they create. Ownership of a topic is used to determine which publisher 114 receives a message from a client 106, deals with subscription, and/or creates dynamic topics. Publishers 114 hosted in the data distribution system server 110 may act as client applications to other data distribution system servers. A publisher 114 may do this by subscribing to topics on the other servers to create a distributed architecture.

The topic tree 116 represents a model of the organizational structure of the topics available to be published to clients and which the clients can subscribe to. The topic tree is arranged hierarchically and comprised of top-level topics with subordinate topics underneath those top-level topics. These subordinate topics can themselves have subordinate topics. A topic of any type can be bound to any node of the topic tree. The topic tree 116 may be maintained by the publisher 114, client sessions module 120, or by other software within the data distribution system server 110.

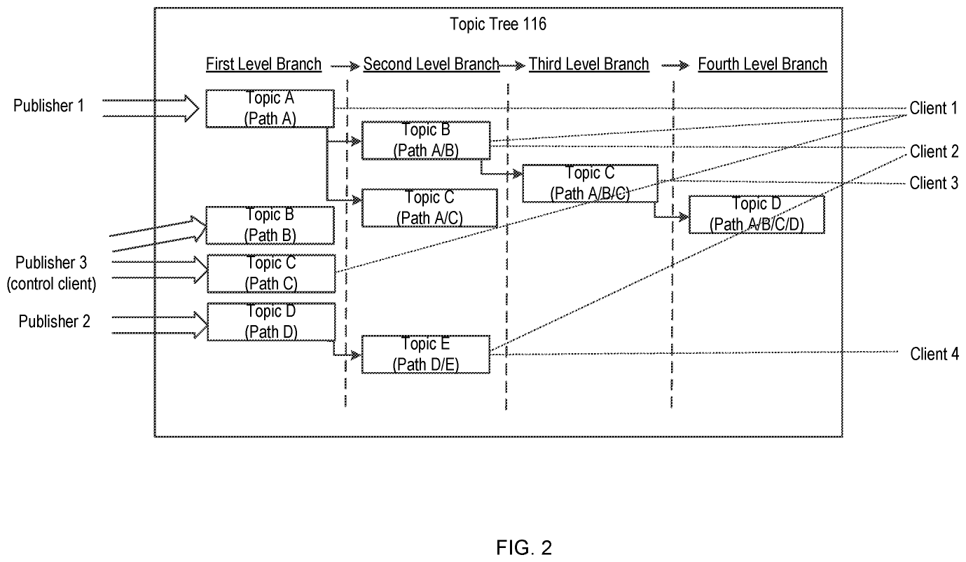

FIG. 2 is a diagram illustrating a topic tree, and logical connections between publishers and clients based on topics, according to one embodiment. In one example, topics may be arranged in a tree structure. Topic names A, B, C and D are at the highest level of the tree structure. Topic names B and C are subordinate to topic name A in the second level of the tree structure. Topic name E is subordinate to topic name D in the second level of the tree structure. Topic name C is subordinate to topic name B in the third level of the tree structure. Topic name D is subordinate to topic name C in the fourth level of the tree structure.

The location of a topic in the topic tree is described by the topic path. The topic path can include the topic name and all the topics above it in the topic tree in an order separated by the slash character (/). For example, referring to the second level of the topic tree 116, the path to topic B is A/B and the path to topic E is D/E. The topic tree may include any number of topics, and the topic tree shown in FIG. 2 is just one example of a topic tree.

Clients 106 and publishers 104 are loosely coupled through logical links representing the topics. A publisher 104 publishes messages to a topic and a client 106 subscribes to a topic and receives its messages. For example, Publisher 1 can publish to topic A or any topic subordinate to topic A. Publisher 2 can publish to topic D at path D, or any topic subordinate to that topic. Publisher 3 can publish to topic B at path B or topic C at path C, or any topic subordinate to those topics

Client 1 is subscribed to receive messages from Topic A at path A, topic B at path A/B, and Topic C at path C. Client 2 is subscribed to receive messages from Topic B at path A/B and Topic E at path D/E. Client 3 is subscribed to receive messages from Topic B at path A/B. Client 4 is subscribed to receive messages from Topic E at path D/E.

A topic path may also be used by a client 106 to send messages to the publisher 104 that receives messages on that topic path. The client is not aware of the publisher, only of the topic path.

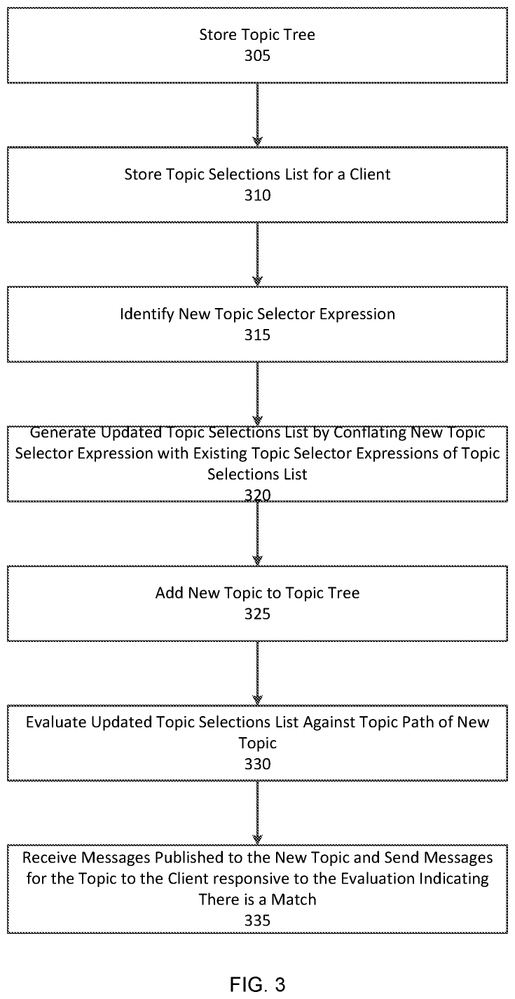

Topics are created in the data distribution system server 110 by publishers 104. Each topic can have a topic name within the data distribution system server 110. As shown in FIG. 3, the topic names are A, B, C, D, and E. The same topic names can appear in multiple locations within the topic tree. For example, topic name D appears one time in the first level of the tree at path D, and again in the fourth level of the tree at path A/B/C/D. The two appearances of topic name D are treated as separate topics since they appear at different topic paths. In other embodiments, the topic names in the topic tree 116 can be unique.

Referring back to FIG. 1, the client sessions module 120 maintains subscription information about the topics each client 106 is subscribed to. For each client 106, the subscription information includes a list of topic selections. A topic selection includes data that identifies a subset of topics of the topic tree 116 and whether the client 106 is subscribed to that subset of topics of the topic tree 116. Each topic selection includes a topic selector, which is a hierarchical wild-card expression that identifies a subset of the topic tree. The topic selector may be referred to herein as a topic selector expression. The data distribution system server 110 uses topic selectors to subscribe client sessions to appropriate topics. Each topic selection also includes a subscription operation type value indicating whether the topic selector is subscribing to or unsubscribing from the topic tree. Specific examples of a topic selection and the topic selectors will be explained in further detail in the section titled “Topic Conflation Overview.”

A client session uses subscribe and unsubscribe operations to change its topic selections. Each operation adds a new topic selector to the client's topic selections. When a new topic is added by the publisher 114, the topic's path is evaluated against every client session's unique topic selections. To reduce the cost of evaluation, topic selections for a client are conflated to remove redundant selectors. The process used for topic selection conflation will be explained in further detail in the section titled “Topic Conflation Overview”.

FIG. 3 illustrates a method of operating the data distribution system to reduce computational costs, according to one embodiment. The method shown in FIG. 3 can be performed by the data distribution system server 110.

In step 305, a topic tree 116 is stored in memory and maintained by the data distribution system server 110. The topic tree 116 is comprised of a plurality of topics that clients 106 can subscribe to. The topics in the topic tree 116 are organized into a topic hierarchy with several subordinate levels, as previously described by reference to FIG. 2.

In step 310, a topic selection list for a client 106 is generated and stored into memory. The list can be generated by accumulating several topic selector expressions over time into the topic selection list. The topic selection list includes a list of topic selector expressions and their associated subscription operation type values. Each topic selector expression in the list identifies a different subset of the topic tree which is being subscribed to or unsubscribed from. The topic selector expressions have a specific ordering within the topic selection list. The topic selector expressions are ordered from oldest to newest, with the oldest topic selector expressions being at the beginning of the list and the newest topic selector expressions being at the end of the list.

A separate list of topic selector expressions is maintained for each client 106 since different clients 106 will subscribe to different topics. The topic selector expressions can be evaluated against the topic tree 116 to identify topics a client 106 has subscribed to. Publishers can publish messages to the topics, which are received by the data distribution server 110, and those messages are then selectively transmitted to the clients 106 that subscribed to those topics.

In step 315, a new topic selector expression for a client 106 is identified. For example, a client 106 may request to subscribe or unsubscribe to a portion of the topic tree 116, which results in the generation of the new topic selector expression. The new topic selector expression identifies a subset of the topic tree which is being subscribed to or unsubscribed from, and may or may not overlap with the existing topic selector expressions. The new topic selector expression is associated with a subscription type value that indicates whether the new topic selector expression is subscribing to or unsubscribing from the topic tree 116.

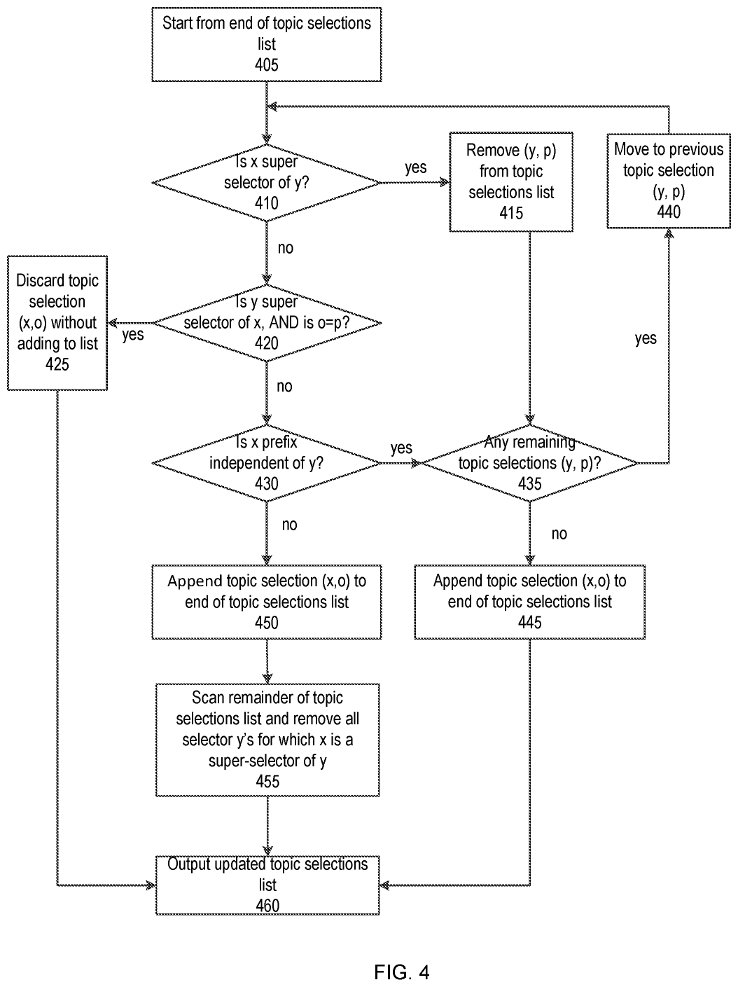

In step 320, an updated topic selection list for a client 106 is generated by conflating the new topic selector expressions with the existing topic selector expressions in the topic selection list. The conflation can involve determining whether there is redundancy between the new topic selector expressions and the existing topic selector expressions, and adding or removing topic selector expressions depending on whether there is a redundancy. Redundancy can be detected, for example, by evaluating whether there is overlap between the selected topic paths of various topic selector expressions, and whether there is complete independence between the selected topic paths of various topic selector expressions. Step 320 will be described in a later portion of the description by reference to FIG. 4.

In step 325, a new topic is added to the topic tree by a publisher 114. The topic is located at a specific topic path in the topic tree. In step 330, the new topic's path is evaluated against a client's updated topic selection list to determine if the topic path matches the client's topic selector expressions. The purpose of the evaluation is to determine if the client 106 has subscribed to the topic path of the new topic.

Each client 106 has its own list of topic selector expressions that are evaluated separately against the topic's path. Each topic selection list can include a large number of topic selector expressions. Thus, when there are a large number of topic selection lists (e.g. thousands of lists), each having a large number of topic selector expressions (e.g. a hundred topic selectors), a large number of topic selector expressions have to be evaluated against a single topic path. The process of evaluating the topic selector expressions against the topic path is therefore extremely computationally expensive. However, by streamlining the topic selection lists using the conflation process described herein, the speed of the data distribution system server 110 in evaluating the topic selections can be increased, and the memory requirements needed for performing the evaluation can be reduced. Both of these benefits are examples of technical improvements to the functioning of the data distribution system server 110.

In step 335, a publisher 114 publishes messages to the topic, which are received by the data distribution system server 110. The messages for the new topic are sent to the client 106 during a client session responsive to the evaluation of step 330 indicating that there is a match between the new topic path and the topic paths subscribed to by the client's updated topic selections list. If the evaluation step 330 does not indicate there is a match, the messages for the new topic are not sent to the client 106. Eventually the client session may be terminated. When this happens, the list of topic selections for the client session can be deleted as it is no longer needed.

### Topic Conflation Overview

### Subscription Matching

The conflation of topic selector expressions is now described in greater detail. Generally, in the disclosed publisher-subscriber system, a client session will be subscribed to a topic by the data distribution system server 110 if: (1) a subscribe operation provides a topic selector that selects an existing topic; and (2) a newly created topic is selected by the session's topic selections.

The data distribution system server 110 removes a subscription from a session when an unsubscribe operation removes a selector, when a subscribed topic is removed, and when the session is closed.

### Topic Selectors

Subscription matching evaluates topic selectors against topic paths. The selects operation is used to determine whether a topic matches a topic path. The selects operation uses two parameters: a topic selector and a topic path, and returns a Boolean result (yes/no) indicating whether the given selector matches (i.e. “selects”) the path. The following expression represents a type signature that defines the inputs (Selector) and (TopicPath), and outputs (Boolean) for the selects operation.
selects::Selector->TopicPath->Boolean

There are several types of selectors. All selectors share the same general form, which includes the following three components:
1. A path prefix, which equals the start of any matching path.
2. An optional wildcard expression, expressed as various forms of regular expression depending on the selector type. The expression constrains the remainder of candidate paths. The path prefix is chosen to be as large as possible, so the wildcard expression never starts with a fixed path.
3. A descendant qualifier, which uses the hierarchical nature of the topic tree to indicate whether to include all of the descendant (child) paths, and whether to include the match itself. Each descendant qualifier is one of:
   matches—select only the matching paths;
   descendants-of-match—select only descendants of matching paths;
   match-and-descendants—select matching paths and their descendants.

The following two examples illustrate the three components of a topic selector:
Example 1: A selector with a fixed path prefix of a/b, no wildcard expression, and descendant qualifier of “matches” exactly matches the single topic path a/b.
Example 2: A selector with a fixed path prefix of a/b, a wildcard expression c. *, and descendant qualifier of “descendants-of-match” matches the topic paths a/b/c/d, a/b/c2/d and a/b/c2/d/e (a/b/c2/d and a/b/c2/d/e are not shown in FIG. 2). It does not match a/b/c because of the descendants-of-match qualifier.

### Selector Expressions

The data distribution system server 110 uses a string representation of a topic selector called a “selector expression.” The selector expression includes the prefix, wildcard, and descendant qualifier described previously. The prefix, wildcard, and selector expression are expressed using a specific syntax. This syntax will be explained below. However, the syntax in this description is simply provided for purposes of explanation only and in other embodiments a different syntax may be used.

The initial character or prefix component of the selector expression determines the selector type as shown in Table 1 below.

TABLE 1

| Prefix | Interpretation |
|---|---|
| > | A path selector, with no wildcard. This indicates any “*” |
| (optional) | characters that appear in the path prefix are not intended to |
| | represent a wildcard but are actual characters in a path name. |
| * | A full path selector, where the wildcard is a regular expression |
| | matched against the remaining path |
| ? | A split path selector, where the wildcard is a sequence of |
| | regular expressions, matched part-wise against the remaining |
| | parts of the path but not the subordinate paths. |

The following examples illustrate the difference between a full path selector and a split path selector. The examples are based on FIG. 2, but with an additional Topic of c2 located at path a/b/c2.

An example of a full path selector is “*a/b/c.*”. This full path selector includes a wildcard of “c.*”. The wildcard matches topic paths a/b/c, a/b/c2 and a/b/c/d because the path prefix matches a/b/and the remainder of these paths begins with c.

An example of a split path selector is “?a/b/c.*”. This split path selector includes a wildcard of “c.*”. The wildcard matches topic paths a/b/c and a/b/c2. The split path selector does not match a/b/c/d, which is subordinate to a/b/c, because the wildcard for a split path selector is not matched against subordinate paths.

As previously discussed, descendant qualifier component of the selector expression indicates whether to include all of the descendant paths, and whether to include the match itself in the topic selector. The default descendant qualifier is matches. Full path and split path selectors can modify the descendant qualifier through an expression suffix as described in Table 2 below.

TABLE 2

| Suffix | Interpretation |
|---|---|
| (none) | matches |
| / | descendants-of-match |
| // | match-and-descendants |

Returning to the topic selector examples shown in Example 1 and Example 2, the topic selector of Example 1 may be expressed as topic selector expression “>a/b” (or simply “a/b”). In this expression, “>a/b” is the prefix. “>” is the initial character of the prefix and indicates that there is no wildcard. There is no wildcard expression or descendant qualifier. Only path “a/b” matches this expression.

The topic selector of Example 2 may be expressed as topic selector expression “*a/b/c.*/”. In this expression “*a/b” is the prefix. “*” is the initial character of the prefix and indicates this expression is a full path selector. The “c.*” is a wildcard. The ending character “I” indicates that the qualifier is descendants-of-match. Only paths a/b/c/d, a/b/c2/d and a/b/c2/d/e match this expression, but path a/b/c does not match because of the descendants-of-match qualifier.

The data distribution system server 100 also supports a composite set selector that has no string representation. A set selector is a collection of non-set selector expressions. A set selector matches a topic path if any of its member selector expressions match the topic path.

### Topic Selections

A primary topic selections operation can be evaluated to test whether a particular topic selector matches a topic path. This operation corresponds to step 330 from FIG. 3. The following expression represents a type signature that defines the inputs (TopicSelections) and (TopicPath) and outputs (Boolean) for the selects operation:
selects::TopicSelections->TopicPath->Boolean

Topic selections may be modelled as an append-only list of pairs [(Selector, Operation)]. The Selector is the previously defined topic selector expression. The Operation is a data value that can be subscribe or unsubscribe, and corresponds to the previously described subscription operation type value. Each topic selection is thus a combination of a Selector identifying a subset of the topic tree, and an Operation specifying a type of the subscription operation associated with the Selector, such as whether the Selector is subscribing a client 106 to or unsubscribing the client 106 from a subset of the topic tree.

The list accumulates over time as the client session performs subscription operations. For example, if a client session subscribes to *a//, unsubscribes from *a/b/, and then subscribes to a/b/c/d in this order, its topic selections would be:
a//, subscribe
a/b/, unsubscribe
a/b/c/d, subscribe

“a//, subscribe” subscribes to path a, a/b, a/c, a/b/c and a/b/c/d in FIG. 2. “*a/b/, unsubscribe” unsubscribes from a/b/c and a/b/c/d. “a/b/c/d, subscribe” subscribes to a/b/c/d. This example selects path a, a/b, a/c, a/b/c/d, but not a/b/c.

To evaluate selects, the data distribution system server 110 iterates over the list in reverse order by starting at the end of the topic selections list where the most recently added topic selector is located. The data distribution server 110 iterates over the list looking for the first selector that selects the path. If a selector is found, the result of the evaluation is true if its paired operation is subscribe, and false if the operation is unsubscribe. On the other hand, if no selector is found, the result is false. The iteration order is important as later subscription operations refine the topic selections.

### Topic Selector Conflation

The cost of evaluating selects for topic selections is O(n), where n is the number of selectors. The topic selections memory footprint is also O(n). Consequently, to reduce the computational cost of evaluating selects and also to reduce the memory footprint, a new selector is not simply appended to the topic selections. Instead, it is conflated using a conflate operation. The conflate operation takes three arguments: a TopicSelections; a Selector; and an Operation; and returns a different TopicSelections. The following expression represents a type signature that defines the inputs (TopicSelections), (Selector), and (Operations); and outputs a different and updated (TopicSelections') for the conflate operation.
conflate::TopicSelections->Selector->Operation->TopicSelections'

The TopicSelections is a list of topic selections for a client 106. The Selector is a topic selector expression that identifies a subset of the topic tree that is being selected. The Operation specifies whether the Selector is subscribing or unsubscribing to the topic tree.

The conflate operation implemented by the data distribution system server 110 examines the selector/operation pairs (i.e. the topic selections) within the current list of topic selections and removes any selector/operation pairs (i.e. the topic selections) that the new selector makes redundant. The conflate operation also considers whether the new selector is itself redundant, and discards it if so.

In one example, the data distribution system server 100 employs the conflate operation to replace equal selectors. For example, conflating the new selector/operation pair (a, unsubscribe) with the topic selections represented by the following sequence of selector/operation pairs:
a, subscribe
b, subscribe
   results in the topic selections
b, subscribe

This result is because the new topic selection of “a, unsubscribe” cancels the operation of the existing topic selection of “a, subscribe.” Therefore “a, subscribe” can be removed.

The data distribution system server 100 also applies the conflation operation to descendant qualifiers, so conflating the selector/operation pair (?a//, subscribe) with the topic selections represented by the following sequence of selector/operation pairs:
a/b, subscribe
b, subscribe
   results in the topic selections
b, subscribe
?a//, subscribe

This result is because the new topic selection of “?a//, subscribe” subscribes to a, a/b, a/c, a/b/c and a/b/c/d. “a/b, subscribe” only subscribes to a/b and is completely covered by “?a//, subscribe” and can therefore be removed. The order of the topic selections in the results is arbitrary because the two resulting topic selections are independent of each other.

Effective conflation has secondary benefits:
The data distribution system server 110 interns topic selections to save memory. “Interning” immutable objects refers to replacing references to equal instances with references to a single instance. Reducing the number of representations of the same effective topic selections reduces memory cost.
When adding a topic, the results of the selects operation are cached and reused (“memorized”) to avoid repeated evaluation for sessions have the same topic selections. Thus, if two clients 106 have the exact same topic selector expression, the topic selector expression can simply be evaluated once for the first client, the results can be saved, and then the results can also be used for the second client instead of reevaluating the topic selector expression again for the second client section. Reducing the number of representations improves the likelihood of two sessions having the same topic selections.

### The Super-Selector Relation

The implementation of conflate uses two relations, super-selector and prefix-independent. The super-selector relation is transitive and reflexive, and therefore establishes a preorder over selectors. It is not antisymmetric; e.g. “>a” and “?a” are not equal but both select only a, so are super-selectors of each other. As super-selector is defined as follows:
Definition 1. For two selectors, x and y, x is a super-selector of y<=> for all p: y selects p=>x selects p

In definition 1, the notation <=>means “if and only if”, the notation “p” means topic paths, and the notation “=>” means implies that. Definition 1 indicates that selector x is a super-selector of y if and only if, for all topic paths that y selects, x also selects those topic paths. Thus, if x is a super selector of y, x completely covers all topic paths selected by y.

The super-selector relation is not optimized to be efficiently evaluated for all selectors, in particular for selectors with wildcard expressions. An example of a wildcard expression is “a/b/c.*”. To compare wildcard expressions, the regular expressions would need to be parsed and evaluated to determine all topic paths selected by the wildcard expression. This is a process that is significantly CPU-intensive. However, it is straightforward to evaluate super-selector for selectors that have no wildcard expression. The implementation uses the following operation, with the “maybe” value indicating the possibility of false negative results:
is-super-selector::Selector->true maybe

The super-selection operation outputs a “true” if selector x is a super selector of y. The super-selector operation outputs a “maybe” if selector x is not a super selector of y, or if x or y include a wildcard that makes the selector too CPU intensive to evaluate.

### The Prefix-Independent Relation

The implementation of conflate also uses a prefix-independent relationship. The following definition describes a prefix-independent relation as follows:
Definition 2. For two selectors, x and y, x is independent of y<=> for all p:y
selects p=>not x selects p

Definition 2 indicates that selector x is independent of selector y if and only if, for all topic paths that y selects, x does not select those same topic paths. Thus, if x and y are prefix-independent, they select different portions of the topic tree and there is no overlap in the topic paths selected by the two topic selectors.

The prefix-independent relation is symmetric, but neither transitive nor reflexive.

The prefix-independent relation is not optimized to be evaluated efficiently due to the potential presence of wildcard expressions in the selectors. However, a simpler relation can be evaluated precisely using the following definition:
Definition 3. For two selectors, x with path prefix xp and y with path prefix yp, x is prefix-independent of y<=>xp is not equal to yp, xp is not a parent of yp, and yp is not a parent of xp
is-prefix-independent::Selector->Boolean

Definition 3 indicates that x is prefix-independent of y if and only if these three conditions are met: (1) the path prefix of x is not equal to the path prefix of y, (2) the path prefix of x is not a parent of the path prefix of y, and (3) the path prefix of y is not a parent of the path prefix of x.

Only the path prefix, and not any wildcards that follow the path prefix, are evaluated by Definition 3. For example, if a selector is “a/b/c.*”, the wildcard “c.*” would be ignored and only the path prefix of “a/b” would be considered by Definition 3. Because wildcards of the topic selector are ignored, Definition 3 is an approximation of Definition 2 that is less computationally intensive to process than Definition 2.

### Process for Conflating Topic Selectors

For simplicity, the process written here modifies the topic selections ts in place. To conflate (x, o) with topic selections ts, the process iterates over each selector/operation pair in ts in reverse order and for each pair (y, p):
If x is super-selector y, remove y from ts.
Otherwise, if y is-super-selector x and o equals p, discard x and exit.
Otherwise if x is-prefix-independent y, move on to the next y.
Otherwise it is unknown how x and y are related so conflation of the remaining y's is limited. Append x to ts. Scan remainder of ts, remove ally's for which x is a super-selector of y, and exit.
If the end of the list is reached, append x to ts, and exit.

(x, o) is a new topic selection. x is a topic selector and o is an subscription operation type value indicating whether topic selector x is a subscribe or unsubscribe operation. (y, p) is a an existing topic selection in the list of topic selections, where y is a topic selector and p is a subscription operation type value indicating whether topic selector y is a subscribe or unsubscribe operation.

This conflation process is further explained by reference to FIG. 4. FIG. 4 is a flowchart illustrating additional details for the step 320 of generating an updated topic selection list by conflating a new topic selector with an existing list of topic selectors from FIG. 3, according to one embodiment.

In step 405, the process starts at the end of the topic selections list ts. The topic selections list includes several topic selections in the form of selector/operation pairs (y, p). The last topic selector in the topic selections list represents the most recent topic selector in the list, whereas the first topic selector in the topic selections list represents the oldest topic selector in the list. The last selector/operation pair in the list is initially selected for processing.

In step 410, it is determined if topic selector x is a super selector of topic selector y. This step involves determining if, for all topic paths that topic selector y selects, topic selector x also selects those topic paths. If this condition is true, then topic selector x covers all topic paths selected by topic selector y, and topic selector x is deemed to be a super selector of topic selector y. Therefore topic selector y is redundant of topic selector x, and in step 415 the topic selection (y, p) is no longer needed and can be removed from the topic selections list.

If the result of step 410 is no, the process moves to step 420. In step 420 it is determined if topic selector y is a super selector of topic selector x. This step involves determining if, for all topic paths that topic selector x selects, topic selector y also selects those topic paths. If this condition is true, then topic selector y covers all topic paths selected by topic selector x, and topic selector y is deemed to be a super selector of topic selector x. Step 420 also involves determining if both topic selectors represent the same type of subscribe operation (o=p). Both topic selections are the same type of subscribe operation of they are both subscribe operations, or if they are both unsubscribe operations. This step involves comparing the subscription operation type value (o) associated with topic selector x to the subscription operation type value (p) of topic selector y.

If topic selector y is a super selector of topic selector x, AND both topic selectors represent the same type of subscription operation, then topic selector x is a redundant selector that is not needed. The process then moves to step 425 where the new topic selection (x, o) is discarded without being added to the topic selections list. If the result of step 420 is no, the process moves to step 430.

In step 430 it is determined if topic selector x is prefix independent of topic selector y. This step involves determining if, the topic paths selected by topic selector x are completely independent of the topic paths selected by topic selector y. This step can be performed in accordance with Definition 2. This step can also be performed in accordance with Definition 3, which disregards wildcards in the topic prefixes of topic selector x and topic selector y.

If topic selector x is prefix independent of topic selector y, then the process moves to step 435. In step 435 it is determined whether there are any remaining topic selections in the topic selections list. If so, in step 440 the previous topic selection is selected and the process repeats at step 410. If there are no more remaining topic selections in the list, then the process moves to step 445. In step 445, the new topic selection (x, o) is appended to the end of the topic selections list. The new topic selection is added to the list because it is not redundant to the existing topic selections, but is instead independent of all other topic selections in the list (as determined from step 430) and is also not completely covered by any existing topic selections (as determined from step 420).

If x is not prefix independent of y, then the specific relationship between x and y is not known. Thus, in step 450, topic selection (x, o) is now added to the topic selections list. In step 455 the remainder of the topic selections list is scanned. For each topic selector y in the list, it is determined if topic selector x is a super selector of that topic selector y. If topic selector x is a super selector of a topic selector y, the topic selector y is removed from the list of topic selections. In step 460, the updated topic selections list is then output.

### OTHER CONSIDERATIONS

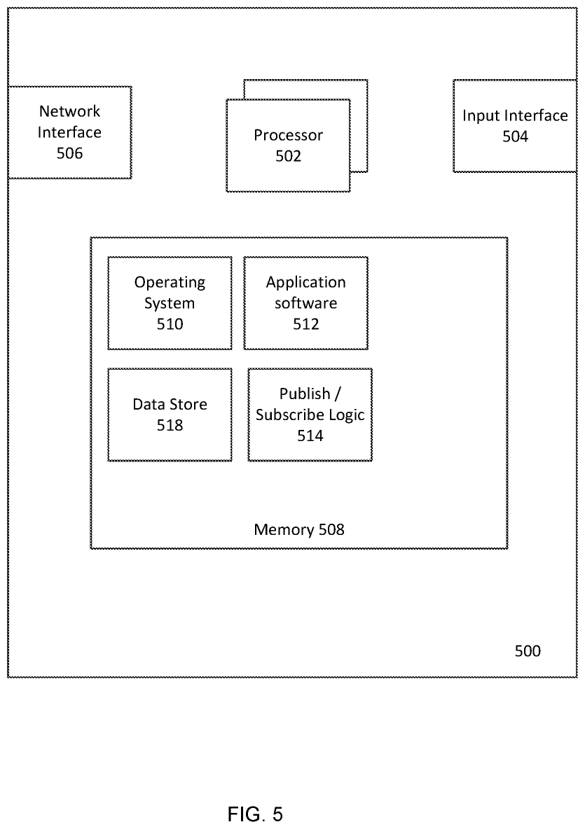

FIG. 5 is a schematic diagram of a computing device 500 for implementing a server 110, according to one embodiment. The computing-based device 500 may be implemented as any form of a computing and/or electronic device in which embodiments of the pub/sub system may be implemented.

The computing-based device 500 comprises one or more processors 502 which may be microprocessors, controllers or any other suitable type of processors for processing computer executable instructions to control the operation of the device in order to manage and control publish and subscribe operations in a pub/sub system. In some examples, for example where a system on a chip architecture is used, the processors 502 may include one or more fixed function blocks (also referred to as accelerators) which implement a part of the queue serving and transmission methods in hardware (rather than software or firmware).

The computing-based device 500 also comprises an input interface 504, arranged to receive messages relating to a topic from the publishers 114 when the publishers 114 are in an external system 102, and at least one network interface 506 arranged to send and receive data messages over the communication network 180. In some examples, the input interface 504 and network interface 506 can be integrated.

Computer executable instructions may be provided using any non-transitory computer-readable media that is accessible by the computing based device. Non-transitory computer-readable media may include, for example, computer storage media such as memory 508 and communications media. Computer storage media, such as memory 508, includes volatile and non-volatile, removable and non-removable media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. Although the computer storage media (memory 508) is shown within the computing-based device it will be appreciated that the storage may be distributed or located remotely and accessed via a network or other communication link (e.g. using network interface 506).

Platform software comprising an operating system 510 or any other suitable platform software may be provided at the computing-based device 500 to enable application software 512 to be executed on the device. Additional software provided at the device may include publish/subscribe logic 514 for implementing the various functions described herein. The memory 508 can also provide a data store 518, which can be used to provide storage for data used by the processors 502 when performing the queue serving and transmission operations. This can include storing of the messages from the publishers and storing of the virtual queues.

The term ‘computer’ is used herein to refer to any device with processing capability such that it can execute instructions. Those skilled in the art will realize that such processing capabilities are incorporated into many different devices and therefore the term ‘computer’ includes PCs, servers, mobile telephones, personal digital assistants and many other devices.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Various other modifications, changes and variations which will be apparent to those skilled in the art may be made in the arrangement, operation and details of the method and apparatus of the present embodiments disclosed herein without departing from the spirit and scope of the disclosure as defined in the appended claims. Therefore, the scope of the disclosure should be determined by the appended claims and their legal equivalents.

1. A method of distributing information to a client using a subscription system that maintains a topic tree comprised of a plurality of topics that clients can subscribe to, the topics in the topic tree organized in a topic hierarchy, the method comprising:
storing a topic selection list for the client, the topic selection list comprising a plurality of first topic selector expressions received by the subscription system from the client, a first topic selector expression selecting a corresponding first subset of the topic tree which is being subscribed to or unsubscribed from by the client;
identifying a second topic selector expression received by the subscription system from the client, the second topic selector expression selecting a corresponding second subset of the topic tree which is being subscribed to or unsubscribed from by the client;
updating the topic selection list for the client by conflating the plurality of first topic selector expressions with the second topic selector expression based on whether there is redundancy between the first topic selector expressions and the second topic selector expression;
receiving an indication of a new topic added to the topic tree by a publisher, the new topic having a topic path;
evaluating the updated topic selection list against the topic path of the new topic added to the topic tree to determine whether the client is subscribed to the new topic; and
transmitting one or more messages for the new topic to the client responsive to the evaluation indicating that the client is subscribed to the new topic.

2. The method of claim 1, wherein conflating the plurality of first topic selector expressions with the second topic selector expression comprises:
determining whether topic paths of the topic tree selected by the first topic selector expression are all selected by the second topic selector expression,
wherein the topic selection list is updated based on whether topic paths of the topic tree selected by the first topic selector expression are also all selected by the second topic selector expression.

3. The method of claim 1, wherein conflating the plurality of first topic selector expressions with the second topic selector expression comprises:
determining, for the first topic selector expression of the list of first topic selector expressions, whether topic paths of the topic tree selected by the second topic selector expression are also all selected by the first topic selector expression, and
wherein the topic selection list is updated based on whether topic paths of the topic tree selected by the second topic selector expression are also all selected by the first topic selector expression.

4. The method of claim 3, wherein conflating the plurality of first topic selector expressions with the second topic selector expression comprises:
determining whether a subscription type associated with the first topic selector expression is same as a subscription type associated with the second topic selector expression; and
wherein the topic selection list is updated further based on whether the subscription type associated with the first topic selector expression is same as the subscription type associated with the second topic selector expression.

5. The method of claim 1, wherein conflating the plurality of first topic selector expressions with the second topic selector expression comprises:
determining whether topic paths of the topic tree selected by the first topic selector expression are independent of topic paths of the topic tree selected by the second topic selector expression, and
wherein the topic selection list is updated based on whether topic paths of the topic tree selected by the first topic selector expression are independent of topic paths of the topic tree selected by the second topic selector expression.

6. The method of claim 5, wherein the first topic selector expression includes a topic path and a wildcard associated with the topic path, wherein the wildcard is disregarded when determining whether topic paths of the topic tree selected by the first topic selector expression are independent of topic paths of the topic tree selected by the second topic selector expression.

7. The method of claim 1, wherein conflating the plurality of first topic selector expressions with the second topic selector expression comprises:
evaluating the first topic selector expressions of the list of first topic selections in reverse order.

8. The method of claim 1, wherein the first topic selector expression includes a corresponding path prefix that identifies a corresponding topic path corresponding to the subset of the topic tree.

9. The method of claim 1, wherein the first topic selector expression is associated with a value that indicates whether the topic selector expression is subscribing to or unsubscribing from the topic tree, and the conflating is further based on the value that indicates whether the topic selector expression is subscribing to or unsubscribing from the topic tree.

10. (canceled)

11. A non-transitory computer readable medium storing computer program instructions for distributing information to a client using a subscription system that maintains a topic tree comprised of a plurality of topics that clients can subscribe to, the topics in the topic tree organized in a topic hierarchy, the computer program instructions executable by a processor to perform operations comprising:
storing a topic selection list for the client, the topic selection list comprising a plurality of first topic selector expressions received by the subscription system from the client, a first topic selector expression selecting a corresponding first subset of the topic tree which is being subscribed to or unsubscribed from by the client;
identifying a second topic selector expression received by the distribution system from the client, the second topic selector expression selecting a corresponding second subset of the topic tree which is being subscribed to or unsubscribed from by the client;
updating the topic selection list for the client by conflating the plurality of first topic selector expressions with the second topic selector expression based on whether there is redundancy between the first topic selector expressions and the second topic selector expression;
receiving an indication of a new topic added to the topic tree by a publisher, the new topic having a topic path;
evaluating the updated topic selection list against the topic path of the new topic added to the topic tree to determine whether the client is subscribed to the new topic; and
transmitting one or more messages for the new topic to the client responsive to the evaluation indicating that the client is subscribed to the new topic.

12. The non-transitory computer readable medium of claim 11, the instructions to perform operations of conflating the plurality of first topic selector expressions with the second topic selector expression executable to perform further operations comprising:
determining whether topic paths of the topic tree selected by the first topic selector expression are all selected by the second topic selector expression,
wherein the topic selection list is updated based on whether topic paths of the topic tree selected by the first topic selector expression are also all selected by the second topic selector expression.

13. The non-transitory computer readable medium of claim 11, the instructions to perform operations of conflating the plurality of first topic selector expressions with the second topic selector expression executable to perform further operations comprising:
determining, for the first topic selector expression of the list of first topic selector expressions, whether topic paths of the topic tree selected by the second topic selector expression are also all selected by the first topic selector expression, and
wherein the topic selection list is updated based on whether topic paths of the topic tree selected by the second topic selector expression are also all selected by the first topic selector expression.

14. The non-transitory computer readable medium of claim 13, the instructions to perform operations of conflating the plurality of first topic selector expressions with the second topic selector expression executable to perform further operations comprising:
determining whether a subscription type associated with the first topic selector expression is same as a subscription type associated with the second topic selector expression; and
wherein the topic selection list is updated further based on whether the subscription type associated with the first topic selector expression is same as the subscription type associated with the second topic selector expression.

15. The non-transitory computer readable medium of claim 11, the instructions to perform operations of conflating the plurality of first topic selector expressions with the second topic selector expression executable to perform further operations comprising:
determining whether topic paths of the topic tree selected by the first topic selector expression are independent of topic paths of the topic tree selected by the second topic selector expression, and
wherein the topic selection list is updated based on whether topic paths of the topic tree selected by the first topic selector expression are independent of topic paths of the topic tree selected by the second topic selector expression.

16. The non-transitory computer readable medium of claim 15,
wherein the first topic selector expression includes a topic path and a wildcard associated with the topic path, wherein the wildcard is disregarded when determining whether topic paths of the topic tree selected by the first topic selector expression are independent of topic paths of the topic tree selected by the second topic selector expression.

17. The non-transitory computer readable medium of claim 11, the instructions to perform operations of conflating the plurality of first topic selector expressions with the second topic selector expression executable to perform further operations comprising
evaluating the first topic selector expressions of the list of first topic selections in reverse order.

18. The non-transitory computer readable medium of claim 11, wherein the first topic selector expression includes a corresponding path prefix that identifies a corresponding topic path corresponding to the subset of the topic tree.

19. The non-transitory computer readable medium of claim 11, wherein the first topic selector expression is associated with a value that indicates whether the topic selector expression is subscribing to or unsubscribing from the topic tree, and the conflating is further based on the value that indicates whether the topic selector expression is subscribing to or unsubscribing from the topic tree.

20. (canceled)

21. A system for distributing information to a client using a subscription system that maintains a topic tree comprised of a plurality of topics that clients can subscribe to, the system comprising:
a computer processor for executing computer program instructions; and
a non-transitory computer-readable medium storing computer program instructions executable by the computer processor to perform operations comprising:
storing a topic selection list for the client, the topic selection list comprising a plurality of first topic selector expressions received by the subscription system from the client, a first topic selector expression selecting a corresponding first subset of the topic tree which is being subscribed to or unsubscribed from by the client;
identifying a second topic selector expression received by the distribution system from the client, the second topic selector expression selecting a corresponding second subset of the topic tree which is being subscribed to or unsubscribed from by the client;
updating the topic selection list for the client by conflating the plurality of first topic selector expressions with the second topic selector expression based on whether there is redundancy between the first topic selector expressions and the second topic selector expression;
receiving an indication of a new topic added to the topic tree by a publisher, the new topic having a topic path;
evaluating the updated topic selection list against the topic path of the new topic added to the topic tree to determine whether the client is subscribed to the new topic; and
transmitting one or more messages for the new topic to the client responsive to the evaluation indicating that the client is subscribed to the new topic.
